(19) United States
(12) Patent Application Publication
(10) Pub. No.: US 2007/0098201 A1
(43) Pub. Date: May 3, 2007

(54) Earplug type earphone

(76) Inventor: Chung-Hsien Chen, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/263,908

(22) Filed: Nov. 2, 2005

(51) Int. Cl. H04R 25/00

(52) U.S. Cl. 381/380

(57) ABSTRACT

This invention relates to an earplug type earphone that includes a front cover, a back cover, an earplug, a signal line, and a signal line support member, and the earplug is sheathed into a fixed pillar with a bias design and protruded from the back cover, so that earplug with an eccentric structure can adjust the wearing tightness, and the back cover can be turned clockwise or counterclockwise with respect to the front cover to fix the fixed pillar to the back cover with an eccentric design in the lower left side or lower right side with an eccentric design, and fit the user's left and right ears and enhance the utility of the earphone.

### BACKGROUND OF THE INVENTION

1. Field of the Invention

This invention relates to an earplug type earphone comprising a front cover, a rear casing, a plug, a signal line, and a signal line supporting member, and the earplug is connected to a fixed pillar of the back cover, so that the earplug is substantially an eccentric structure for adjusting the wearing tightness, and the back cover can be rotated clockwise or counterclockwise with respect to the front cover, such that the bias structure of the fixed pillar back cover is disposed proximate to the lower left side or lower right side to fit the user's left and right ears and enhance the practical use of the earphone.

2. Description of the Related Art

In a traditional earplug type earphone, the body of the earphone comprises an ear pad to be plugged into the user's ear and a casing for containing a speaker, so that when the earphone is used, the whole earphone is plugged directly into the user's ear according to the shape of the ear pad, and the speaker is attached to the user's ear hole, so that the sound produced by the speaker will be transmitted directly into the user's ear and thus achieving the hearing effect.

Since the prior art earplug type earphone directly installs the speaker inside the ear pad, therefore it is necessary to wear the ear pad onto the user's ear for the use of the earphone. However, the size of the speaker is limited by the volume of the ear pad, and it is unable to adopt a larger speaker having a better base effect, and thus such prior art will affect the base performance of the overall earphone. Furthermore, the casing and the speaker have to match with the ear pad which comes with a circular design, particularly the speaker directly transmits the sound from the surface of the ear pad, and the speaker cannot achieve the effect of collecting sound, and thus the performance of the sound quality will be poor and awkward.

As to the structure of the sound generator of the prior art earplug type earphone, the output section of the sound generator is usually made of a hard material, and thus it is necessary to install a sponge cover to wrap the sound generator.

Since the material and thickness of a sponge cover is relatively weak and small, the material wrapped onto the output section of the sound generator will be embedded into the user's auditory tube, and the porous sponge material will adhere dirt or germs. The dirty sponge cover cannot be removed easily for cleaning, and thus making the repeated uses of the sponge cover unlikely. Furthermore, the material of the sponge cover cannot be fixed easily, and the sponge cover may be loosen or even embedded into or separated from the ear. Such traditional way of installing the sponge cover onto the earphone cannot provide a good protection for its application.

To overcome the existing shortcomings of the prior art products and make their application more convenient and practical, the inventor of the present invention based on years of experience on related area and aimed at the foregoing shortcomings to conduct researches and developments and maximize the practicability of the present invention, and finally invented an improved earplug type earphone structure.

### SUMMARY OF THE INVENTION

The primary objective of this invention is to provide an earplug type earphone comprising a front cover, a back cover, an earplug, a signal line, and a signal line support member. The earplug is connected to a fixed pillar with an eccentric design disposed at the back cover, so that the eccentric structure of the earplug allows a user to adjust the wearing tightness. Furthermore, the back cover can be turned clockwise or counterclockwise with respect to the front cover, so that the fixed pillar with the eccentric design at the back cover can be set to the lower left side or the lower right side to fit the user's left and right ears and enhance the utility of the earphone.

To make it easier for our examiner to understand the objective of the invention, its structure, innovative features, and performance, we use a preferred embodiment together with the attached drawings for the detailed description of the invention.

Referring to FIGS. 1 and 2 for the earplug type earphone in accordance with the present invention, the earphone 10 comprises a front cover 20, a back cover 30, an earplug 40, a speaker 50, a signal line 61, a signal line support member 60, and a decorative plate 70.

The front cover 20 is a circular casing having a circular latch flange 21 around the external periphery of the circular casing, and the front cover 20 includes a circular groove 22 disposed at the side of the latch flange 21, and the groove 22 includes a plurality of fixing members formed by two fixed protrusions 23, and the front cover 20 includes a hollow slot 24.

Referring to FIG. 3, the back cover 30 is a circular casing having a fixed pillar 31 with an eccentric design, and the fixed pillar 31 includes a stairway rod penetrating its middle, and the back cover 30 includes a plurality of raised dots 32 disposed and fixed on one side of the back cover 30.

The earplug 40 is a cylindrical sleeve made of a soft material (preferably a silica gel material), and the circumferential surface of the earplug 40 comes with a streamlined curved design, and the earplug 40 is sheathed and fixed onto the pillar 31 of the back cover 30.

The signal line support member 60 includes a signal line 61 penetrating its middle and the signal line 61 is connected to the speaker 50, and the signal line support member 60 is embedded into the slot 24 at the bottom of the front cover 20 by the arc latch member 62 at the top of the front cover 20, and a decorative plate 70 is attached on the external side of the front cover 20, and the front cover 20 is connected to the back cover 30, such that the positioning raised dots 32 of the back cover 30 are latched and fixed into the groove 22 of the front cover 20 by the fixing component formed by two positioning protrusion 23 to form an integral structure.

### BRIEF DESCRIPTION OF THE DRAWINGS

FIG. 1 is a perspective view of the present invention;

FIG. 2 is an exploded view of the present invention;

FIG. 3 is a schematic view of the internal structure of a back cover of the present invention;

FIGS. 4 and 5 are schematic views of turning the back cover according to the present invention; and

FIGS. 6 and 7 are schematic views of the practical use of the present invention.

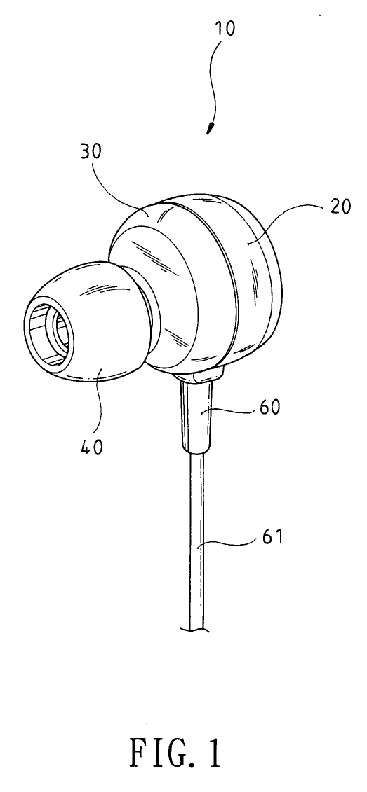

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

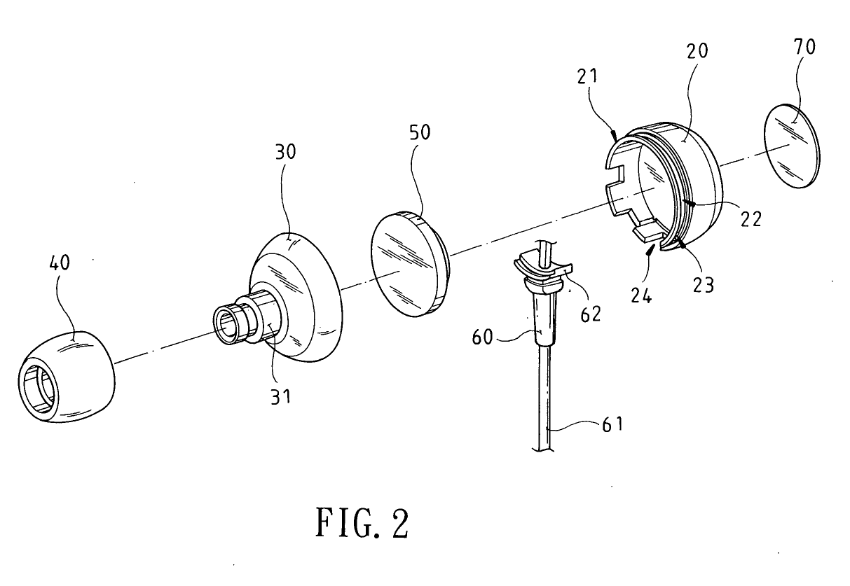

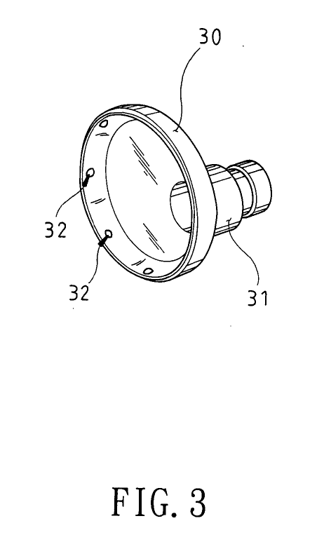

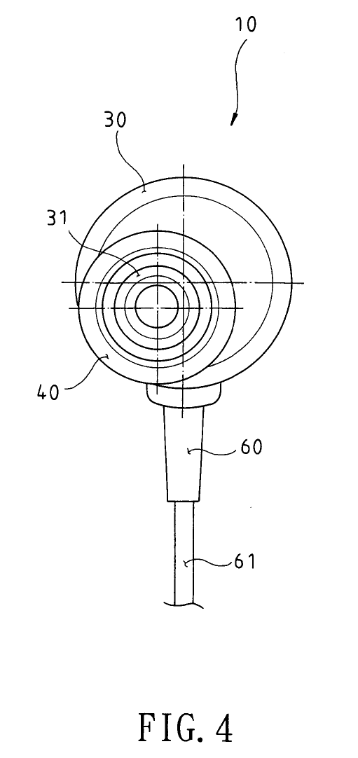

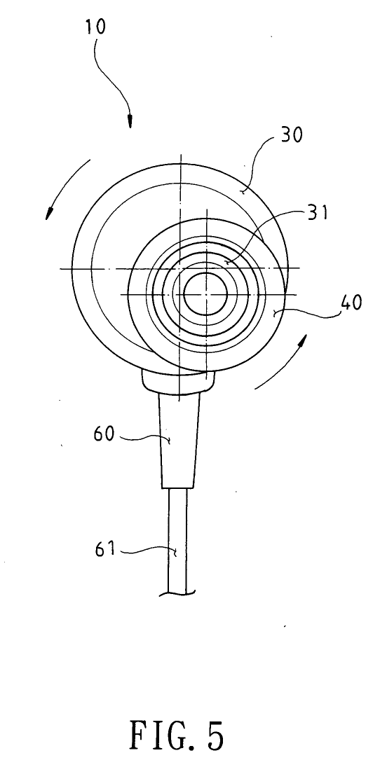

The present invention integrates the foregoing components into a whole earplug type earphone as shown in FIG. 4, and the back cover 30 of the earphone 10 is disposed at the lower left side of the external side and fixed to the fixed pillar 31 with an eccentric design, and the earplug 40 is sheathed and fixed onto the fixed pillar 31 of the back cover 30, so that the earplug 40 is eccentric with respect to the back cover 30. Referring to FIGS. 2 and 3, the back cover 30 includes a plurality of positioning raised dots 32 disposed on one side of the internal edge. The positioning raised dots 32 are latched and fixed into the groove 22 of the front cover 20 by a positioning component formed by two positioning protrusions 23. A user can apply a slight force to turn and adjust the back cover 30. The fixed pillar 31 of the back cover 30 is disposed on the lower left side with an eccentric design, so that the user can turn the back cover 30 counterclockwise, and the fixed pillar 31 of the back cover 30 drives the earplug 40 to be installed from the left lower side with an eccentric design and turned to the lower right side with an eccentric design as shown in FIG. 5. As we know that human ears are symmetrically on the left and right sides, the earplug 40 of the invention can be turned and adjusted clockwise or counterclockwise by the back cover 30, so that the earplug 40 can be installed on the lower left side or lower right side with a bias design to fit the structure of the left and right ears of the user and enhance the utility of the product.

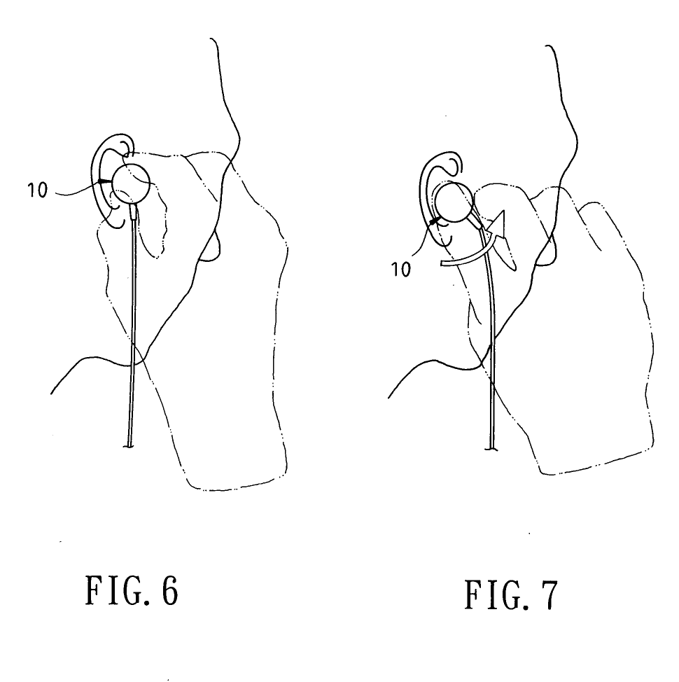

Further, the earplug 40 of the invention adopts a bias design and takes the structure of human ears into consideration. Referring to FIGS. 6 and 7 for the practical use of the present invention, the earphone 10 is turned slightly forward when the earphone is plugged into an ear (as shown by the arrow direction in FIG. 7) and fixed onto the external edge of the ear. Such eccentric design allows the earphone 10 to be turned clockwise or counterclockwise when a user wears the earphone 10, and thus the earphone 10 will moves eccentrically with the ear hole as the center, and the earplug pushes the cartilage of the acoustic labyrinth of the external ear, so as to fit different ears of different sizes. The earphone 10 can be secured into the ear, and the user can turn the earphone 10 to different angles to achieve the most comfortable and pressure-free wearing. This design also can provide an airtight contact between the earphone 10 and the ear to provide the best sound performance for the earphone 10. In summation of the above description, the present invention not only has innovative improvements on its space configuration, but also maximizes the performance and enhances the performance than the conventional structure and further complies with the patent application requirements.

While the invention has been described by means of specific embodiments, numerous modifications and variations could be made thereto by those skilled in the art without departing from the scope and spirit of the invention set forth in the claims.

What is claimed is:

1. An earplug type earphone, comprising a front cover, a back cover, an earplug, a speaker, a signal line, a signal line support member and a decorative plate; wherein:
said front cover, being a circular casing and having a circular latch flange protruded from the external periphery on one side of said circular casing, and said front cover is latched with a side of said latch flange and has a circular groove, and said groove includes a plurality of positioning components formed by two positioning protrusions and disposed in said groove, and said front cover includes a hollow slot disposed on one side of the bottom of said front cover;
said back cover, being a circular casing and disposed on a fixed pillar with an eccentric design, and said fixed pillar includes a stairway rod penetrating the middle of said fixed pillar, and said back cover includes a plurality of positioning raised dots disposed evenly on one side of the internal edge of said back cover;
said earplug is a cylindrical sleeve made of silica gel, and the circumferential surface of said earplug comes with a streamlined curved design, and said earplug is sheathed and fixed onto said fixed pillar of said back cover; and
said signal line support member contains a signal line penetrating the middle of said signal line support member, and said signal line is coupled to said speaker, and said signal line support member is embedded into a slot disposed at the bottom edge of said front cover by said arc latch member at the top, and a decorative plate is attached on the external side of said front cover, and said front cover and said back cover are coupled with each other such that said positioning raised dots of said back cover are latched and fixed into said groove of said front cover by said positioning component comprised of two positioning protrusions to form an integrated structure.
